(19) United States
(12) Patent Application Publication
(10) Pub. No.: US 2025/0270065 A1
(43) Pub. Date: Aug. 28, 2025

(54) TAPE ATTACHING APPARATUS

(71) Applicant: SAMSUNG SDI CO., LTD., Gyeonggi-do (KR)

(72) Inventors: Dong Hyuk KO, Gyeonggi-do (KR); Yoon Jae JEONG, Gyeonggi-do (KR); Hyun Soo KIM, Gyeonggi-do (KR)

(73) Assignee: SAMSUNG SDI CO., LTD., Gyeonggi-do (KR)

(21) Appl. No.: 18/913,443

(22) Filed: Oct. 11, 2024

(30) Foreign Application Priority Data
Feb. 26, 2024 (KR) 10-2024-0027217

(51) Int. Cl. B65H 20/18; B65H 23/26; B65H 35/00; H01M 10/04

(52) U.S. Cl. CPC B65H 20/18; B65H 23/26; B65H 35/0013; H01M 10/0404; B65H 2301/446; B65H 2301/5151; B65H 2405/53; B65H 2701/1722; B65H 2801/00

(57) ABSTRACT

Examples of the present disclosure relate to a tape attaching apparatus of which an installation space is reduced, with productivity of tape attaching work improved, and accuracy of a tape attachment position is improved. Examples of the present disclosure include a tape attaching apparatus including a tape supply unit that supplies a tape, an electrode plate supply unit that supplies an electrode plate, and a rotating head that receives the tape supplied from the tape supply unit and rotates to attach the tape to the electrode plate supplied from the electrode plate supply unit.

### CROSS-REFERENCE TO RELATED APPLICATION

The present application claims the benefit of priority from Korean Patent Application No. 10-2024-0027217, filed on Feb. 26, 2024 in the Korean Intellectual Property Office, the entire disclosure of which being incorporated herein by reference.

### BACKGROUND

### 1. Field of the Invention

Examples of the present disclosure relates to a tape attaching apparatus.

### 2. Discussion of Related Art

Generally, the demand for portable electronic products such as, e.g., laptop computers, video cameras, portable phones, and the like, is increasing, and robots, electric vehicles, and the like are commercialized in earnest. Thus, research on high-performance secondary batteries capable of repeated charging and discharging is actively conducted.

A secondary battery includes a case and an electrode assembly accommodated inside the case. The electrode assembly includes a pair of electrode plates, and a separator interposed between the pair of electrode plates. Typically, each, or at least one, of the electrode plates includes a foil-shaped electrode current collector and an electrode active material with which a surface of the electrode current collector is coated.

An uncoated portion not coated with the electrode active material may be formed on the electrode plate. A tape may be attached to the uncoated portion to reduce or prevent short circuit.

### SUMMARY OF THE INVENTION

An aspect of embodiments of the present disclosure is directed to providing a tape attaching apparatus of which an installation space is reduced or minimized, that has an improved productivity of tape attaching work, and an improved accuracy of a tape attachment position.

However, some technical objectives to be achieved by examples of the present disclosure are not limited to the above-described objectives, and other objectives, which are not described above, will be clearly understood by those skilled in the art through the following description of the disclosure.

According to an example aspect of the present disclosure, a tape attaching apparatus includes a tape supply unit configured to supply a tape, an electrode plate supply unit configured to supply an electrode plate, and a rotating head that receives the tape supplied from the tape supply unit and rotates to attach the tape to the electrode plate supplied from the electrode plate supply unit.

The rotating head may receive the tape from the tape supply unit at a tape transfer point, and rotate in one direction to attach the tape to the electrode plate at a tape attachment point.

After the tape is attached to the electrode plate at the tape attachment point, the rotating head may further rotate in the one direction, which is the same direction as above, to return to the tape transfer point.

The tape may include an adhesive surface coated with an adhesive, and a non-adhesive surface which is opposite to the adhesive surface that is not coated with the adhesive, and the rotating head may be configured to adsorb the non-adhesive surface at the tape transfer point and stop the adsorption of the non-adhesive surface at the tape attachment point.

The rotating head may push the tape toward the electrode plate so that the adhesive surface adheres to the electrode plate at the tape attachment point.

The rotating head may be provided as, or include, a plurality of rotating heads, and the plurality of rotating heads may be arranged at, e.g., substantially equiangular intervals with respect to the same rotation center.

The tape attaching apparatus may further include a rotation frame that supports the plurality of rotating heads and rotates about the rotation center.

The tape transfer point may be provided as, or include, a plurality of tape transfer points, the tape attachment point may be provided as, or include, a plurality of tape attachment points, and the number of tape transfer points and the number of tape attachment points may be the same, and the number of rotating heads may be a multiple of the number of tape transfer points and the number of tape attachment points, e.g., the number of rotating heads may be twice the number of tape transfer points and the number of tape attachment points.

The tape may be transferred to one of the plurality of rotating heads from the tape supply unit at one of the plurality of tape transfer points, transferred to the electrode plate from the one rotating head at one of the plurality of tape attachment points, and attached to the electrode plate, and the one tape transfer point and the one tape attachment point may be spaced apart from each other by about 180° with respect to a rotation center of the rotating head.

A size of the tape transferred to one of the plurality of rotating heads at one of the plurality of tape transfer points may be different from a size of the tape transferred to another of the plurality of rotating heads at another of the plurality of tape transfer points.

The tape supply unit may be provided as, or include, a plurality of tape supply units in, e.g., a one-to-one correspondence with the tape transfer points, and the electrode plate supply unit may be provided as, or include, one electrode plate supply unit.

The tape supply unit may include a tape supply roller that is configured to substantially seamlessly and continuously supply the tape, and a tape cutter that is configured to cut the tape supplied from the tape supply roller to a desired or preset length.

The tape supply unit may further include a tape gripper that is configured to grip an end portion of the tape fed from the tape supply roller.

In a state in which the tape gripper grips the tape, the rotating head may adsorb the tape, and in a state in which the tape is adsorbed to the rotating head, the tape cutter may cut the tape.

The tape supply unit may further include a tape tension roller that is configured to pull the tape so that tension of the tape is substantially maintained.

The electrode plate supply unit may include an electrode plate supply roller that is configured to substantially seamlessly and continuously supply the electrode plate, and an electrode plate support that supports the electrode plate at the tape attachment point.

The electrode plate supply unit may further include an electrode plate stopping roller that is configured to stop movement of the electrode plate passing through the tape attachment point when the tape is attached to the electrode plate.

The rotating head may rotate after adsorbing the tape at the tape transfer point, may move in a radial direction from a rotation center of the rotating head at the tape attachment point to attach the tape to the electrode plate, may substantially stop the adsorbing of the tape, and may return toward the rotation center.

The electrode plate supply unit may further include an electrode plate tension roller that pulls the electrode plate so that tension of the electrode plate is substantially maintained.

The tape attachment point may be provided as, or include, a plurality of tape attachment points, the electrode plate supply roller may be provided as, or include, one electrode plate supply roller, the electrode plate support may be provided as, or include, a plurality of electrode plate supports provided in a one-to-one correspondence with the tape attachment points, and the plurality of electrode plate supports may be spaced apart from each other on a movement path of the electrode plate supplied from the electrode plate supply roller.

### BRIEF DESCRIPTION OF THE DRAWINGS

The drawings submitted with this specification illustrate example embodiments of the present disclosure, and further describe aspects and features of the present disclosure together with the detailed description thereof. Thus, the present disclosure should not be construed as being limited to the drawings:

FIG. 1 is a diagram of a tape attaching apparatus, according to an example embodiment of the present disclosure;

FIG. 2 is an enlarged view of a tape supply unit of FIG. 1, which is a view illustrating a state in which a rotating head rotates to a tape transfer point, according to an example embodiment of the present disclosure;

FIG. 3 is a view illustrating a state in which an end of a tape is gripped by a tape gripper of FIG. 2, according to an example embodiment of the present disclosure;

FIG. 4 is a view illustrating a state in which the rotating head of FIG. 3 moves in a radial direction and the end of the tape is adsorbed to the rotating head, according to an example embodiment of the present disclosure;

FIG. 5 is a view illustrating a state in which a tape cutter of FIG. 4 cuts the end of the tape, according to an example embodiment of the present disclosure;

FIG. 6 is a view illustrating a state in which the rotating head adsorbs a tape piece and moves toward the center of rotation, according to an example embodiment of the present disclosure;

FIG. 7 is an enlarged view of part A of FIG. 1, which is a cross-sectional view illustrating a state in which the rotating head approaches an electrode plate so that the tape piece adsorbed to the rotating head is attached to the electrode plate, according to an example embodiment of the present disclosure;

FIG. 8 is a plan view illustrating an example of the electrode plate to which the tape piece is attached by the tape attaching apparatus, according to an example embodiment of the present disclosure;

FIG. 9 is a diagram of a tape attaching apparatus, according to an example embodiment of the present disclosure;

FIG. 10 is a plan view illustrating an example of the electrode plate to which the tape piece is attached by the tape attaching apparatus, according to an embodiment of the present disclosure;

FIG. 11 is a diagram of a tape attaching apparatus according to an example embodiment of the present disclosure; and

FIG. 12 is a plan view illustrating an example of the electrode plate to which the tape piece is attached by the tape attaching apparatus according to an example embodiment of the present disclosure.

### DETAILED DESCRIPTION OF EXEMPLARY EMBODIMENTS

Herein, some example embodiments of the present disclosure will be described, in further detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term.

The example embodiments described in this specification and the configurations shown in the drawings are provided as some example embodiments of the present disclosure and do not represent all of the technical ideas, aspects, and features of the present disclosure. Accordingly, it is to be understood that there may be various equivalents and modifications that may replace or modify the example embodiments described herein at the time of filing this application.

It is to be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same or like elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B, and C,” “at least one of A, B, or C,” “at least one selected from a group of A, B, and C,” or “at least one selected from among A, B, and C” are used to designate a list of elements A, B, and C, the phrase may refer to any and all suitable combinations or a subset of A, B, and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

When the terms “about” or “substantially” are used in this specification in connection with a numerical value, it is intended that the associated numerical value include a tolerance of ±10% around the stated numerical value. The expression “up to” includes amounts of zero to the expressed upper limit and all values therebetween. When ranges are specified, the range includes all values therebetween such as increments of 0.1%.

It is to be understood that, although the terms “first,” “second,” “third,” etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It is to be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (e.g., rotated about 90 degrees or at other orientations), and the spatially relative descriptors used herein should be interpreted accordingly.

The terminology used herein is for the purpose of describing example embodiments of the present disclosure and is not intended to be limiting of the present disclosure. As used herein, the singular forms “a” and “an” are intended to include the plural forms as well, unless the context clearly indicates otherwise. It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

References to two compared elements, features, etc. as being “the same” may mean that they are “substantially the same.” Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

When an arbitrary element is referred to as being arranged (or located or positioned) on the “above (or below)” or “on (or under)” a component, it may mean that the arbitrary element is placed in contact with the upper (or lower) surface of the component and may also mean that another component may be interposed between the component and any arbitrary element arranged (or located or positioned) on (or under) the component.

In addition, it is to be understood that when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly electrically connected to another part or one or more intervening parts may be present therebetween such that the part and the “another” part are indirectly electrically connected to each other.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

The terms used in the present specification are for describing embodiments of the present disclosure and are not intended to limit the present disclosure.

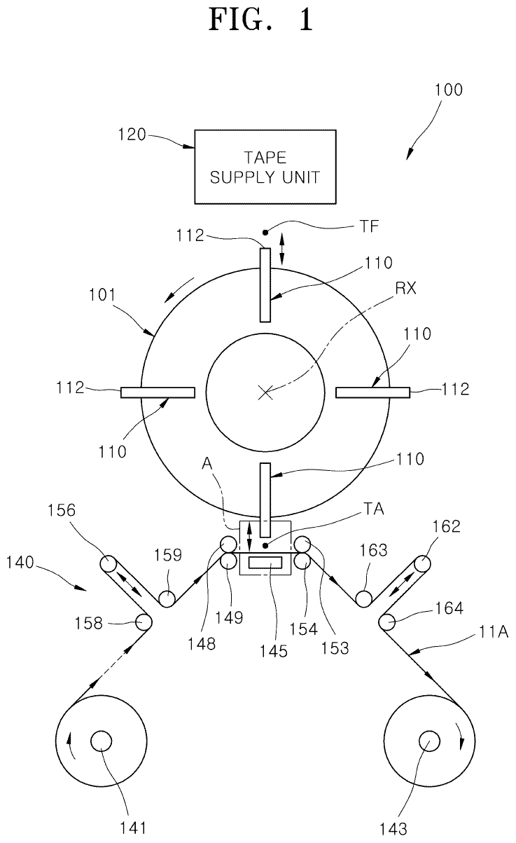

FIG. 1 is a diagram of a tape attaching apparatus according to an example embodiment of the present disclosure.

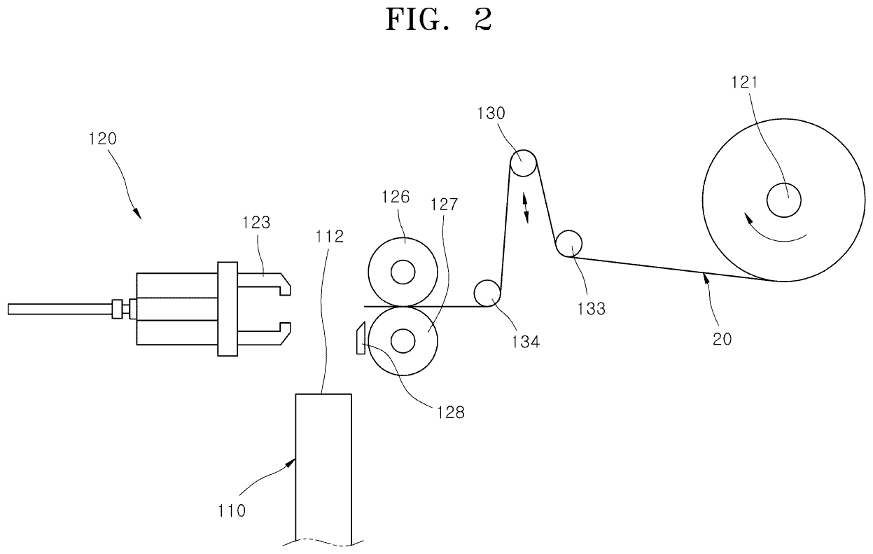

FIG. 2 is an enlarged view of a tape supply unit of FIG. 1, which is a view illustrating a state in which a rotating head rotates to a tape transfer point.

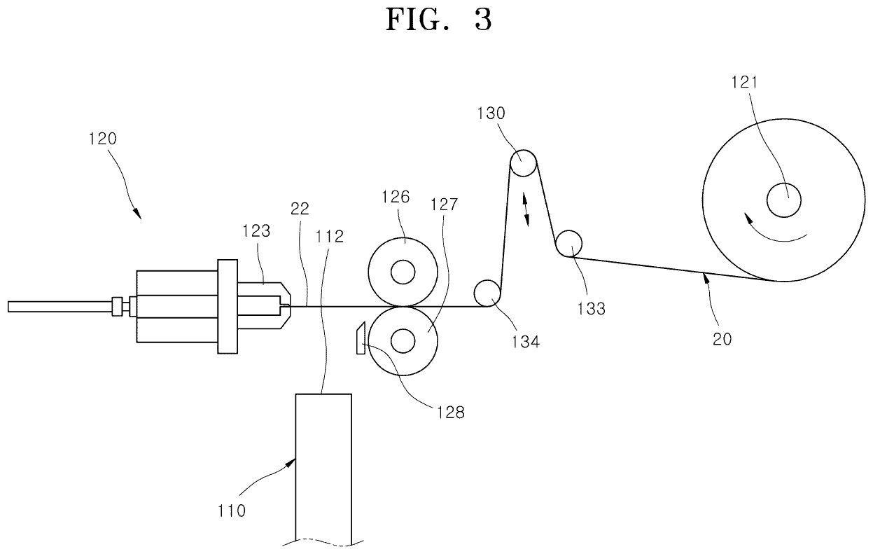

FIG. 3 is a view illustrating a state in which an end of a tape is gripped by a tape gripper of FIG. 2.

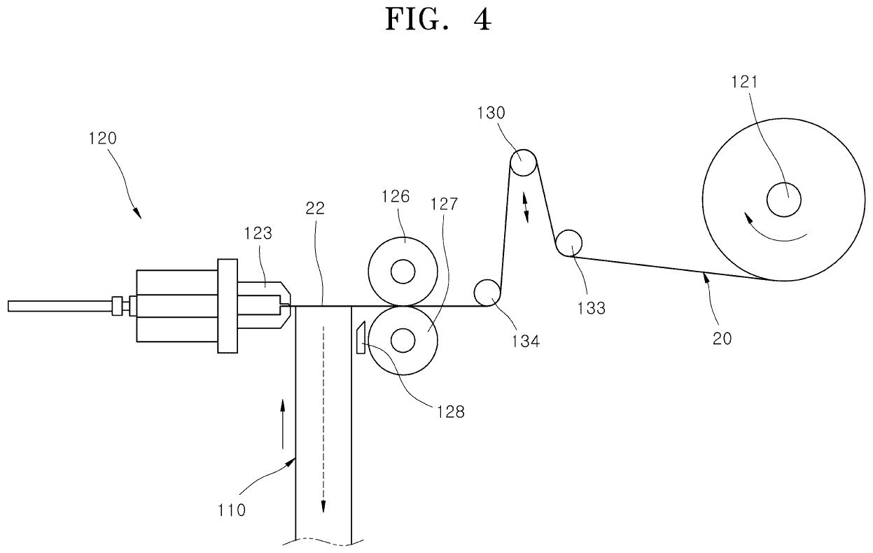

FIG. 4 is a view illustrating a state in which the rotating head of FIG. 3 moves in a radial direction and the end of the tape is adsorbed to the rotating head.

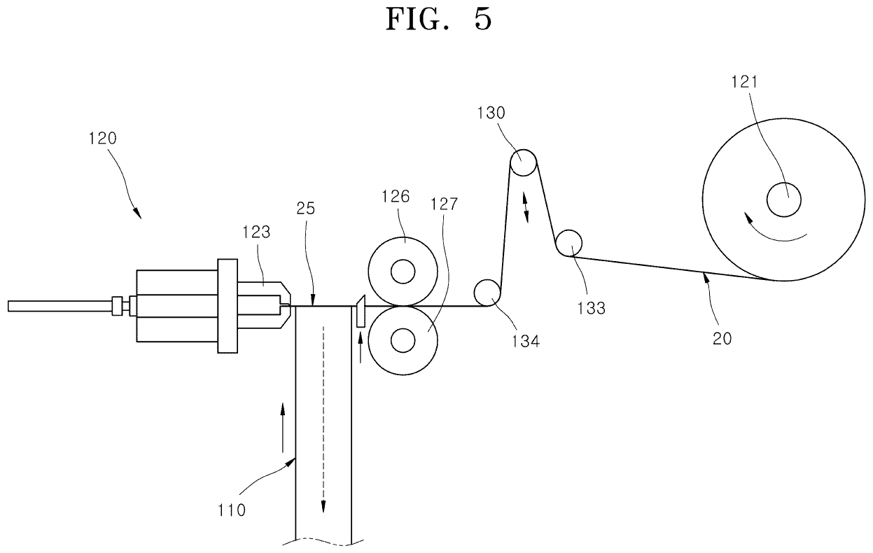

FIG. 5 is a view illustrating a state in which a tape cutter of FIG. 4 cuts the end of the tape.

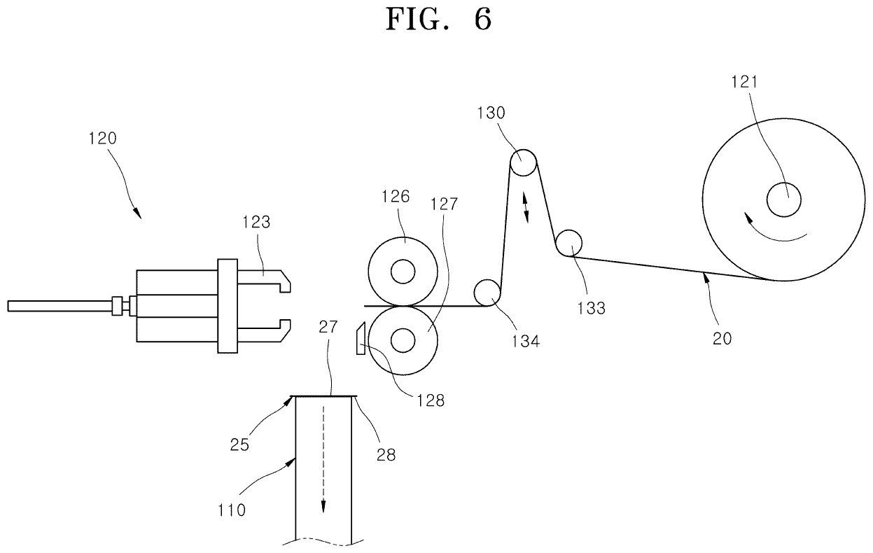

FIG. 6 is a view illustrating a state in which the rotating head adsorbs a tape piece and moves toward the center of rotation.

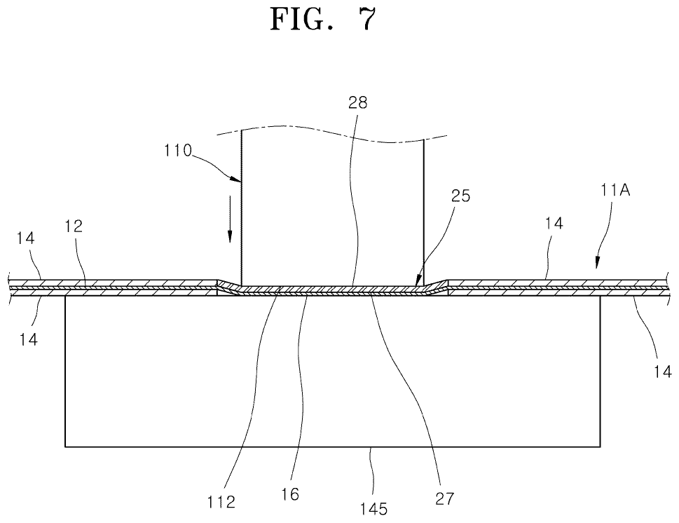

FIG. 7 is an enlarged view of part A of FIG. 1, which is a cross-sectional view illustrating a state in which the rotating head approaches an electrode plate so that the tape piece adsorbed to the rotating head is attached to the electrode plate.

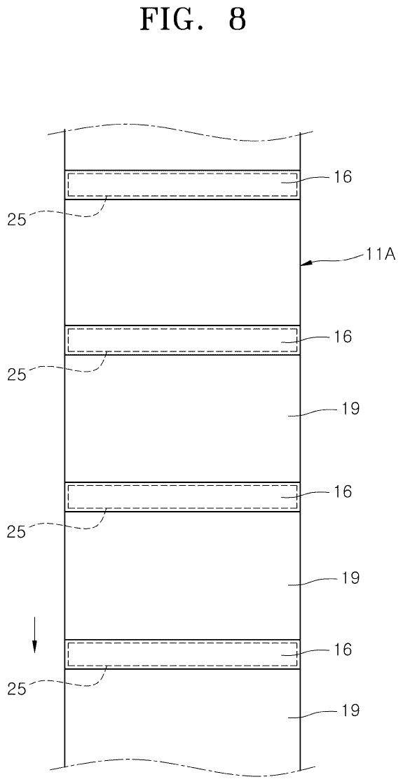

FIG. 8 is a plan view illustrating an example of the electrode plate to which the tape piece is attached by the tape attaching apparatus according to an example embodiment of the present disclosure.

Referring to FIGS. 1 to 8, a tape attaching apparatus 100 according to an example embodiment of the present disclosure is or includes an apparatus for attaching a tape 20 to an electrode plate 11A. In detail, the tape attaching apparatus 100 may automatically attach, to an uncoated portion 16 of an electrode plate 11A, a tape piece 25 of the tape 20 formed by cutting a portion of the tape 20 that continues substantially seamlessly.

The electrode plate 11A, along with a separator, constitutes an electrode assembly. The electrode plate 11A includes an electrode current collector 12 in the form of a foil and an electrode active material layer 14 applied to a surface of the electrode current collector 12 and containing an electrode active material. Since the electrode plate 11A is not coated with the electrode active material layer 14, the uncoated portion 16 through which the electrode current collector 12 is exposed may be formed. An electrode tab (not illustrated) may be welded to the uncoated portion 16. The electrode tab may be electrically connected to a terminal of a secondary battery.

When the electrode plate 11A is a negative electrode plate, the electrode current collector 12 may be a metal foil made of or including, for example, at least one of copper, a copper alloy, nickel, and a nickel alloy. The electrode active material layer 14 may contain, for example, graphite or carbon.

When the electrode plate 11A is a positive electrode plate, the electrode current collector 12 may be a metal foil made of or including, for example, at least one of aluminum and an aluminum alloy. The electrode active material layer 14 may contain, for example, a transition metal oxide.

The tape attaching apparatus 100 includes a tape supply unit 120, an electrode plate supply unit 140, and a rotating head 110. The tape supply unit 120 supplies the tape 20, specifically, the cut tape piece 25 of tape 20. The electrode plate supply unit 140 supplies the electrode plate 11A.

The rotating head 110 receives the tape 20, that is, the tape piece 25 of the tape 20, supplied from the tape supply unit 120, and rotates to attach the tape piece 25 of the tape 20 to the electrode plate 11A supplied from the electrode plate supply unit 140.

The rotating head 110 may be provided as, or include, a plurality of rotating heads 110. The plurality of rotating heads 110 may be arranged at, e.g., equiangular intervals with respect to the same rotation center RX. For example, the rotating heads 110, e.g., four rotating heads 110, may be arranged at, e.g., about 90° intervals with respect to a circle having as a center the rotation center RX. In other examples, the rotating heads 110 may be arranged at other angular intervals with respect to a circle having as a center the rotation center RX

The tape attaching apparatus 100 may further include a rotation frame 101 that is configured to support the plurality of rotating heads 110 and to rotate about the rotation center RX. The rotation frame 101 may rotate in one direction. For example, the rotation frame 101 and the plurality of rotating heads 110 may rotate about the rotation center RX in a counterclockwise direction.

Each, or at least one, of the rotating heads 110 may move away from the rotation center RX and in a backward direction. In other words, the rotating head 110 may move in a radial direction and toward the rotation center RX.

A negative pressure may be formed at a distal end 112 of one or more of the rotating heads 110. Thus, the tape piece 25 of the tape 20 may be adsorbed to the distal end 112 of the rotating head 110. Detailed descriptions of an apparatus configured to rotate and drive the rotation frame 101, an apparatus configured to move the rotating head 110 in the radial direction and toward the rotation center RX, and an apparatus configured to form the negative pressure at the distal end 112 of the rotating head 110 will be omitted.

As illustrated in FIG. 1, the rotating head 110 may receive the tape piece 25 of the tape 20 from the supply unit 120 at a tape transfer point TF and may rotate in one direction to be attached to the electrode plate 11A at a tape attachment point TA. The tape transfer point TF and the tape attachment point TA may be spaced apart from each other at, e.g., about 180° intervals with respect to the rotation center RX. In other examples, the tape transfer point TF and the tape attachment point TA may be spaced apart from each other at other angular intervals with respect to the rotation center RX.

The rotation frame 101 may rotate at a constant speed. However, at a moment that one rotating head 110 among the plurality of rotating heads 110 is positioned at the tape transfer point TF and another rotating head 110 opposite to the one rotating head 110 is positioned at the tape attachment point TA, the rotation of the rotation frame 101 and the plurality of rotating heads 110 supported thereon may temporarily stop.

At a moment that the rotation is stopped, the tape piece 25 of the tape 20 may be adsorbed to the distal end 112 of the one rotating head 110 at the tape transfer point TF, and the tape piece 25 of the tape 20 may be attached to the uncoated portion 16 of the electrode plate 11A at the tape attachment point TA.

For example, in a state in which the one rotating head 110 among the plurality of rotating heads 110 rotationally moves to the tape transfer point TF, the tape piece 25 of the tape 20 is attached to the distal end 112 of the rotating head 110, and the rotating head 110 rotates by about 180° in a counterclockwise direction and moves to the tape attachment point TA. Further, the tape piece 25 of the tape 20 attached to the rotating head 110 is transferred and attached to the uncoated portion 16 of the electrode plate 11A at the tape attachment point TA, and the rotating head 110 rotates by about 180° in the counterclockwise direction as well and moves to the tape transfer point TF.

The tape supply unit 120 may include a tape supply roller 121, a tape gripper 123, tape stopping rollers 126 and 127, a tape cutter 128, and a tape tension roller 130. The tape supply roller 121 unwinds the tape 20 wound in the form of a roll and substantially seamlessly and continuously supplies the tape 20.

The tape 20 may be made of or include a synthetic resin that is an insulating material. The tape 20 includes both side surfaces opposite to each other. One of the side surfaces of the tape 20 may be or include an adhesive surface coated with an adhesive, and the other side surface opposite to the adhesive surface may be or include a non-adhesive surface that is not coated with an adhesive.

The tape gripper 123 may be configured to grip an end portion 22 of the tape 20 fed from the tape supply roller 121. The tape gripper 123 may include a plurality of fingers configured to move in a folding direction in which the tape gripper 123 is folded to grip the end portion 22 of the tape 20, or to move in an unfolding direction opposite to the folding direction.

The tape cutter 128 is configured to cut the end portion 22 of the tape 20 supplied from the tape supply roller 121 to a preset length. The end portion 22 of the tape 20 cut by the tape cutter 128 may become the tape piece 25 of the tape 20 that is adsorbed to the distal end 112 of the rotating head 110.

The tape stopping rollers 126 and 127 are configured to stop movement of the tape 20 when the end portion 22 of the tape 20 is cut by the tape cutter 128. The tape stopping rollers 126 and 127 may be provided as, or include, a pair of tape stopping rollers 126 and 127, and the pair of tape stopping rollers 126 and 127 may be substantially close to each other.

While the end portion 22 of the tape 20 passes between the pair of tape stopping rollers 126 and 127 which are substantially close to each other, when the pair of tape stopping rollers 126 and 127 are stopped, the end portion 22 of the tape 20 is stopped without movement. In this case, the tape cutter 128 may cut the end portion 22 of the tape 20.

The tape tension roller 130 pulls the tape 20 so that the tension of the tape 20 is maintained. The tape tension roller 130 may be on a path of the tape 20 from the tape supply roller 121 to a space between the pair of tape stopping rollers 126 and 127.

The tape supply unit 120 may further include an upstream tension guide roller 133 on an upstream side of the tape tension roller 130 and a downstream tension guide roller 134 on a downstream side of the tape tension roller 130 along the movement path of the tape 20. The tape 20 supplied from the tape supply roller 121 may sequentially pass through the upstream tension guide roller 133, the tape tension roller 130, and the downstream tension guide roller 134 and may enter between the pair of tape stopping rollers 126 and 127.

When the tension of the tape 20 decreases, the tape tension roller 130 may move in a direction that increases the path of the tape 20 and thus increase the tension of the tape 20, and when the tension of the tape 20 increases, the tape tension roller 130 may move in a direction that decreases the path of the tape 20 and thus decrease the tension of the tape 20. Accordingly, the tension of the tape 20 can be maintained to be substantially uniform.

For example, as illustrated in FIG. 3, when the tension of the tape 20 decreases, the tape tension roller 130 may move away from the upstream and downstream tension guide rollers 133 and 134, and when the tension of the tape 20 increases, the tape tension roller 130 may move in a direction closer to the upstream and downstream tension guide rollers 133 and 134. Since the tape tension roller 130 moves and the substantially constant tension of the tape 20 can be maintained, while the pair of tape stopping rollers 126 and 127 are stopped to cut the end portion 22 of the tape 20, the tape supply roller 121 may substantially continuously rotate without stopping.

Hereinafter, a process of transferring the tape piece 25 obtained by cutting the tape 20 to the rotating head 110 will be sequentially described. First, as illustrated in FIG. 2, when the rotating head 110 rotates and then stops at the tape transfer point TF, the end portion 22 of the tape 20 may be interposed between the pair of tape stopping rollers 126 and 127, and a distal end of the tape 20 may protrude from the tape gripper 123.

Next, as illustrated in FIG. 3, the tape gripper 123 may grip the distal end of the tape 20. When the pair of tape stopping rollers 126 and 127 rotate so that the distal end of the tape 20 approaches the tape gripper 123 and then stop, the tape gripper 123 may grip the distal end of the tape 20.

Alternatively, the tape gripper 123 may move closer to the pair of tape stopping rollers 126 and 127 to grip the distal end of the tape 20. Then, the tape gripper 123 may move away from the pair of tape stopping rollers 126 and 127 in turn, and the pair of tape stopping rollers 126 and 127 may rotate so that the tape 20 moves at the same speed as a moving speed of the tape gripper 123.

Next, as illustrated in FIG. 4, the rotating head 110 moves away from the rotation center RX so that the distal end 112 of the rotating head 110 comes into contact with the end portion 22 of the tape 20. Further, a negative pressure is formed at the distal end 112 of the rotating head 110 to adsorb the end portion 22 of the tape 20. The rotating head 110 may adsorb the end portion 22 of the tape 20 in a state in which the tape gripper 123 grips the end portion 22 of the tape 20.

Next, as illustrated in FIG. 5, in a state in which the end portion 22 of the tape 20 is gripped by the tape gripper 123 and adsorbed to the rotating head 110, the tape cutter 128 is operated to cut the end portion 22 of the tape 20 into the tape piece 25. In this case, a non-adhesive surface 28 (see FIG. 6) of the tape piece 25 may be adsorbed to the distal end 112 of the rotating head 110 to face the distal end 112 of the rotating head 110.

Next, as illustrated in FIG. 6, the plurality of fingers of the tape gripper 123 are unfolded to separate the tape piece 25 from the tape gripper 123, and the rotating head 110 moves to an original position thereof, that is, toward to the rotation center RX, while adsorbing the tape piece 25. The tape cutter 128 also returns to an original position thereof.

Referring back to FIG. 1, the electrode plate supply unit 140 may include an electrode plate supply roller 141, an electrode plate collection roller 143, an electrode plate support 145, upstream electrode plate stopping rollers 148 and 149, downstream electrode plate stopping rollers 153 and 154, a first electrode plate tension roller 156, and a second electrode plate tension roller 162. The electrode plate supply roller 141 unwinds the electrode plate 11A wound in the form of a roll and substantially seamlessly and continuously supplies the unwound electrode plate 11A.

With respect to FIGS. 7 and 8, the uncoated portion 16 not coated with the electrode active material layer 14 and a mixture portion 19 coated with the electrode active material layer 14 may be formed on the electrode plate 11A alternately in a longitudinal direction of the electrode plate 11A. The electrode plate collection roller 143 collects the electrode plate 11A having the tape piece 25 attached to the uncoated portion 16 by winding the electrode plate 11A it into a roll shape.

The electrode plate support 145 supports the electrode plate 11A at the tape attachment point TA (see FIG. 1). The rotating head 110, which adsorbs and rotates the tape piece 25 to the distal end 112 and moves to the tape attachment point TA, pushes the tape piece 25 toward the electrode plate 11A so that an adhesive surface 27 of the tape piece 25 adheres to the uncoated portion 16 of the electrode plate 11A. The rotating head 110 moves in the radial direction and away from the rotation center RX illustrated in FIG. 1, the adhesive surface 27 of the tape piece 25 is pressed against and comes into close contact with the uncoated portion 16 of the electrode plate 11A supported on the electrode plate support 145, and thus the tape piece 25 may be substantially firmly attached to the uncoated portion 16.

The electrode plate stopping rollers 148, 149, 153, and 154 stop the movement of the electrode plate 11A passing through the tape attachment point TA when the tape piece 25 is attached to the electrode plate 11A. The electrode plate stopping rollers may include the upstream electrode plate stopping rollers 148 and 149 arranged on an upstream side of the electrode plate support 145 along a movement path of the electrode plate 11A, and the downstream electrode plate stopping rollers 153 and 154 arranged on a downstream side of the electrode plate support 145 along the movement path of the electrode plate 11A.

The upstream electrode plate stopping rollers 148 and 149 may be provided as, or include, a pair of upstream electrode plate stopping rollers 148 and 149, and the downstream electrode plate stopping rollers 153 and 154 may be provided as, or include, a pair of downstream electrode plate stopping rollers 153 and 154. The pair of upstream electrode plate stopping rollers 148 and 149 may be substantially close to each other, and the pair of downstream electrode plate stopping rollers 153 and 154 may be substantially close to each other.

When the electrode plate 11A passes between the pair of upstream electrode plate stopping rollers 148 and 149 substantially close to each other and the pair of downstream electrode plate stopping rollers 153 and 154 substantially close to each other, and when the pair of upstream electrode plate stopping rollers 148 and 149 and the pair of downstream electrode plate stopping rollers 153 and 154 are stopped, a portion of the electrode plate 11A between the upstream electrode plate stopping rollers 148 and 149 and the downstream electrode plate stopping rollers 153 and 154 stops as well. In this case, the rotating head 110 may attach the tape piece 25 to the uncoated portion 16 of the electrode plate 11A.

The electrode plate tension rollers 156 and 162 illustrated in FIG. 1 pull the electrode plate 11A so that tension of the electrode plate 11A is maintained. The electrode plate tension roller may include a first electrode plate tension roller 156 located on an upstream side of the electrode plate support 145 and the upstream electrode plate stopping rollers 148 and 149 along the movement path of the electrode plate 11A and a second electrode plate tension roller 162 located on a downstream side of the electrode plate support 145 and the downstream electrode plate stopping rollers 153 and 154 along the movement path of the electrode plate 11A.

The electrode plate supply unit 140 may further include an upstream first electrode plate tension guide roller 158 on an upstream side of the first electrode plate tension roller 156 and a downstream first electrode plate tension guide roller 159 on a downstream side of the first electrode plate tension roller 156 along the movement path of the electrode plate 11A.

The electrode plate 11A supplied from the electrode plate supply roller 141 may sequentially pass through the upstream first electrode plate tension guide roller 158, the first electrode plate tension roller 156, the downstream first electrode plate tension guide roller 159, and a gap between the pair of upstream electrode plate stopping rollers 148 and 149, and then move onto the electrode plate support 145.

In this section, when a tensile force of the electrode plate 11A decreases, the first electrode plate tension roller 156 may move in a direction that increases the path of the electrode plate 11A, to increase the tensile force of the electrode plate 11A, and when the tensile force of the electrode plate 11A increases, the first electrode plate tension roller 156 may move in a direction that decreases the path of the electrode plate 11A, to decrease the tensile force of the electrode plate 11A. Accordingly, the tensile force of the electrode plate 11A supplied from the electrode plate supply roller 141 and moving to the electrode plate support 145 may be maintained to be substantially uniform.

For example, when the tensile force of the electrode plate 11A decreases, the first electrode plate tension roller 156 may move away from the upstream and downstream first electrode plate tension guide rollers 158 and 159, and when the tensile force of the electrode plate 11A increases, the first electrode plate tension roller 156 may move in a direction closer to the upstream and downstream first electrode plate tension guide rollers 158 and 159.

Since the first electrode plate tension roller 156 moves and the constant tensile force of the electrode plate 11A can be maintained, the electrode plate supply roller 141 may substantially continuously rotate without stopping to attach the tape piece 25 to the electrode plate 11A while the pair of upstream electrode plate stopping rollers 148 and 149 and the pair of downstream electrode plate stopping rollers 153 and 154 are stopped.

The electrode plate supply unit 140 may further include an upstream second electrode plate tension guide roller 163 on an upstream side of the second electrode plate tension roller 162 and a downstream second electrode plate tension guide roller 164 on a downstream side of the second electrode plate tension roller 162.

The electrode plate 11A, on which the tape piece 25 is attached to the uncoated portion 16, may pass between the pair of downstream electrode plate stopping rollers 153 and 154, may sequentially pass through the upstream second electrode plate tension guide roller 163, the second electrode plate tension roller 162, and the downstream second electrode plate tension guide roller 164, and may be collected by the electrode plate collection roller 143.

In this section, when the tensile force of the electrode plate 11A decreases, the second electrode plate tension roller 162 may move in a direction that increases the path of the electrode plate 11A, to increase the tensile force of the electrode plate 11A, and when the tensile force of the electrode plate 11A increases, the second electrode plate tension roller 162 may move in a direction that decreases the path of the electrode plate 11A, to decrease the tensile force of the electrode plate 11A. Accordingly, the tension force of the electrode plate 11A moving from the electrode plate support 145 toward the electrode plate collection roller 143 may be maintained to be substantially uniform.

For example, when the tensile force of the electrode plate 11A decreases, the second electrode plate tension roller 162 may move away from the upstream and downstream second electrode plate tension guide rollers 163 and 164, and when the tensile force of the electrode plate 11A increases, the second electrode plate tension roller 162 may move in a direction closer to the upstream and downstream second electrode plate tension guide rollers 163 and 164.

Since the second electrode plate tension roller 162 moves and the constant tensile force of the electrode plate 11A can be maintained, the electrode plate collection roller 143 may continue to rotate without stopping to attach the tape piece 25 to the electrode plate 11A while the pair of upstream electrode plate stopping rollers 148 and 149 and the pair of downstream electrode plate stopping rollers 153 and 154 are stopped.

Although not illustrated, an electrode tab welding unit, which welds an electrode tab (not illustrated) to the uncoated portion 16 of the electrode plate 11A, may be on the movement path of the electrode plate 11A between the electrode plate supply roller 141 and the first electrode plate tension roller 156. In this case, at the tape attachment point TA, the tape piece 25 may be attached to the uncoated portion 16 to cover the uncoated portion 16 and a portion of the electrode tab welded to the uncoated portion 16.

In a state in which the rotating head 110 that adsorbs the tape piece 25 moves to the tape attachment point TA, and the rotating head 110 and the uncoated portion 16 of the electrode plate 11A are aligned in a radial direction of the rotation center RX, the rotating head 110 may move in the radial direction with respect to the rotation center RX to attach the tape piece 25 to the uncoated portion 16 of the electrode plate 11A. The tape piece 25 may be attached to the electrode plate 11A to cover the uncoated portion 16.

Next, the rotating head 110 may stop adsorbing the tape piece 25 and return toward the rotation center RX. After the tape piece 25 is attached to the electrode plate 11A, the rotating head 110 may further rotate in the same rotation direction as a case in which the rotating head 110 rotates to the tape attachment point TA to move toward the tape transfer point TF.

Although not illustrated in FIGS. 1 and 8, the electrode tab welding unit, which welds the electrode tab (not illustrated) to the uncoated portion 16 of the electrode plate 11A, may be on the movement path of the electrode plate 11A from the electrode plate supply roller 141 toward the first electrode plate tension roller 156. In this case, at the tape attachment point TA, the tape piece 25 may be attached to the uncoated portion 16 to cover the uncoated portion 16 along with the portion of the electrode tab welded to the uncoated portion 16.

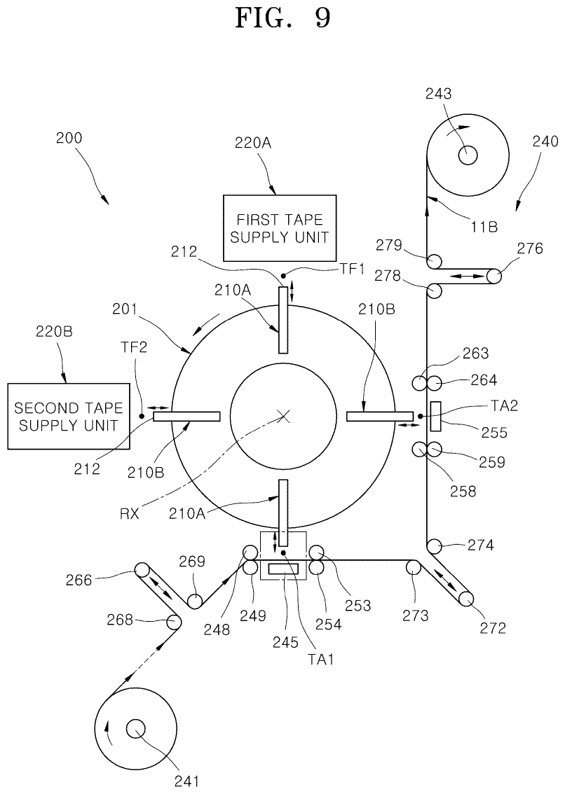

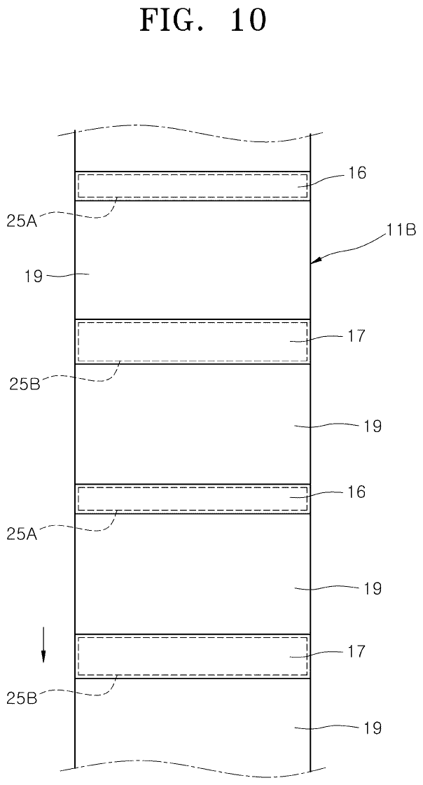

FIG. 9 is a diagram of a tape attaching apparatus according to another embodiment of the present disclosure, and FIG. 10 is a plan view illustrating an example of the electrode plate to which the tape piece is attached by the tape attaching apparatus according to the example embodiment of the present disclosure. Referring to FIGS. 9 and 10, a tape attaching apparatus 200 according to the example embodiment of the present disclosure includes a plurality of tape supply units 220A and 220B, one electrode supply unit 240, a plurality of rotating heads 210A and 210B, and a rotation frame 201.

The tape supply units 220A and 220B supply the tape 20, specifically, tape pieces 25A and 25B of the cut tape 20 illustrated in FIG. 10. The tape supply unit includes a first tape supply unit 220A and a second tape supply unit 220B.

The first tape supply unit 220A is configured to cut the substantially continuous tape 20 (see FIG. 2) and to supply the first tape piece 25A having the same size as the tape piece 25 illustrated in FIG. 8. The second tape supply unit 220B is configured to cut the tape 20 and to supply the second tape piece 25B that is larger than the first tape piece 25A. A width of the tape 20 cut into the second tape piece 25B may be, e.g., larger than a width of the tape 20 cut into the first tape piece 25A.

The rotating heads 210A and 210B are configured to receive the tape pieces 25A and 25B supplied from the tape supply units 220A and 220B, and rotate to attach the tape piece 25A and 25B to an electrode plate 11B supplied from the electrode plate supply unit 240.

The rotating head 210A and 210B may include the first rotating head 210A that is configured to receive and adsorb the first tape piece 25A, and the second rotating head 210B that is configured to receive and adsorb the second tape piece 25B. The first rotating head 210A may be provided as, or include, a pair of first rotating heads 210A, the second rotating head 210B may be provided as, or include, a pair of second rotating heads 210B, and thus a total of four rotating heads may be provided.

The pair of first rotating heads 210A and the pair of second rotating heads 210B may be arranged at equiangular intervals, that is, at about 90° intervals, with respect to the same rotation center RX, and may be arranged alternately. The pair of first rotating heads 210A may be arranged at about 180° intervals with respect to the rotation center RX, and the pair of second rotating heads 210B may be arranged at about 180° intervals with respect to the rotation center RX.

The pair of first rotating heads 210A may be arranged at about 180° intervals with respect to the rotation center RX, and the rotation frame 201 may support the plurality of rotating heads 210A and 210B and rotate about the rotation center RX. The rotation frame 201 may rotate in one direction. For example, the rotation frame 201 and the plurality of rotating heads 210A and 210B may rotate about the rotation center RX in a counterclockwise direction.

Each, or at least one, of the rotating heads 210A and 210B may move away from the rotation center RX and in the backward direction. In other words, the rotating heads 210A and 210B may move in the radial direction and toward the rotation center RX.

A negative pressure may be formed at distal ends 212 of the rotating heads 210A and 210B. Thus, the first tape piece 25A may be adsorbed on the distal end 212 of the first rotating head 210A, and the second tape piece 25B may be adsorbed to the distal end 212 of the second rotating head 210B.

The first rotating head 210A may receive the first tape piece 25A from the first tape supply unit 220A at a first tape transfer point TF1 and rotate in one direction to attach the first tape piece 25A to the first uncoated portion 16 of the electrode plate 11B at a first tape attachment point TA1. The first tape transfer point TF1 and the first tape attachment point TA1 may be spaced apart from each other at about 180° intervals with respect to the rotation center RX.

The second rotating head 210B may receive the second tape piece 25B from the second tape supply unit 220A at a second tape transfer point TF2 and rotate in one direction to attach the second tape piece 25B to a second uncoated portion 17 of the electrode plate 11B at a second tape attachment point TA2. The second tape transfer point TF2 and the second tape attachment point TA2 may be spaced apart from each other at about 180° intervals with respect to the rotation center RX.

The rotation frame 201 may rotate, e.g., at a constant or substantially constant speed. However, at a moment that the plurality of rotating heads 210A and 210B are positioned at the tape transfer points TF1 and TF2 or the tape attachment points TA1 and TA2, the rotation of the rotation frame 201 and the plurality of rotating heads 210A and 210B supported thereon may temporarily stop.

For example, at a moment that the rotation of the rotation frame 201 is stopped, the first tape piece 25A is adsorbed to the distal end 212 of one of the pair of first rotating heads 210A at the first tape transfer point TF1, and the first tape piece 25A may be attached to the first uncoated portion 16 of the electrode plate 11B from the other first rotating head 210A at the first tape attachment point TA1.

Further, the second tape piece 25B is adsorbed to the distal end 212 of one of the pair of second rotating heads 210B at the second tape transfer point TF2, and the second tape piece 25B may be attached to the second uncoated portion 17 of the electrode plate 11B from the other second rotating head 210B at the second tape attachment point TA2.

In a state in which one of the pair of first rotating heads 210A rotates and moves to the first tape transfer point TF1, the first tape piece 25A is attached to the distal end 212 of the first rotating head 210A, and the first rotating head 210A rotates by about 180° in a counterclockwise direction and moves to the first tape attachment point TA1. Further, the first tape piece 25A attached to the first rotating head 210A at the first tape attachment point TA1 is moved and attached to the first uncoated portion 16 of the electrode plate 11B, and the first rotating head 210A rotates by about 180° in a counterclockwise direction again and moves to the first tape transfer point TF1.

In a state in which one of the pair of second rotating heads 210B rotates and moves to the second tape transfer point TF2, the second tape piece 25B is attached to the distal end 212 of the second rotating head 210B, and the second rotating head 210B rotates by about 180° in a counterclockwise direction and moves to the second tape attachment point TA2. Further, the second tape piece 25B attached to the second rotating head 210B at the second tape attachment point TA2 is moved and attached to the second uncoated portion 17 of the electrode plate 11B, and the second rotating head 210B rotates by about 180° in a counterclockwise direction again and moves to the second tape transfer point TF2.

Since the first tape supply unit 220A has the same configuration as the tape supply unit 120 included in the tape attaching apparatus 100 according to the example embodiment of the present disclosure, a duplicated description thereof will be omitted. The second tape supply unit 220B has the same configuration as the tape supply unit 120 included in the tape attaching apparatus 100 according to the example embodiment of the present disclosure with a difference that the second tape supply unit 220B supplies the second tape piece 25B that is larger than the first tape piece 25A, and thus a duplicated description thereof is largely omitted herein.

The electrode plate supply unit 240 may include an electrode plate supply roller 241, an electrode plate collection roller 243, electrode plate supports 245 and 255, first electrode plate stopping rollers 248, 249, 253, and 254, second electrode plate stopping rollers 258, 259, 263, and 264, a first electrode plate tension roller 266, a second electrode plate tension roller 272, and a third electrode plate tension roller 276. The electrode plate supply roller 241 unwinds the electrode plate 11B wound in the form of a roll and substantially seamlessly and continuously supplies the unwound electrode plate 11B.

The electrode plate 11B may be provided with the first uncoated portion 16 and the second uncoated portion 17 not coated with the electrode active material layer 14 and the mixture portion 19 coated with the electrode active material layer 14. A planar size of the second uncoated portion 17 may be larger than a planar size of the first uncoated portion 16. The planar size of the first uncoated portion 16 may correspond to a planar size of the first tape piece 25A, and the planar size of the second uncoated portion 17 may correspond to a planar size of the second tape piece 25B.

The first uncoated portion 16 and the second uncoated portion 17 may be spaced apart from each other in a longitudinal direction of the electrode plate 11B with the mixture portion 19 interposed therebetween. The first uncoated portion 16 and the second uncoated portion 17 may be arranged alternately.

The electrode plate collection roller 243 winds the electrode plate 11B, in which the first tape piece 25A is attached to the first uncoated portion 16 and the second tape piece 25B is attached to the second uncoated portion 17, into a roll shape and collects the wound electrode plate 11B.

The electrode plate supports 245 and 255 may be provided as, or include, a pair of electrode plate supports 245 and 255. The first electrode plate support 245 supports the electrode plate 11B at the first tape attachment point TA1. The second electrode plate support 255 supports the electrode plate 11B at the second tape attachment point TA2.

The first rotating head 210A, which adsorbs the first tape piece 25A at the distal end 212 and rotates to move to the first tape attachment point TA1, pushes the first tape piece 25A toward the electrode plate 11B so that an adhesive surface of the first tape piece 25A adheres to the first uncoated portion 16 of the electrode plate 11B. The first rotating head 210A moves in the radial direction and away from the rotation center RX, the adhesive surface of the first tape piece 25A is pressed against and in close contact with the first uncoated portion 16 of the electrode plate 11B supported on the first electrode plate support 245, and thus the first tape piece 25A may be substantially firmly attached to the first uncoated portion 16.

The second rotating head 210A, which adsorbs the second tape piece 25B at the distal end 212 and rotates to move to the second tape attachment point TA2, pushes the second tape piece 25A toward the electrode plate 11B so that an adhesive surface of the second tape piece 25B adheres to the second uncoated portion 17 of the electrode plate 11B. The second rotating head 210B moves in the radial direction and away from the rotation center RX, the adhesive surface of the second tape piece 25B is pressed against and in close contact with the second uncoated portion 17 of the electrode plate 11B supported on the second electrode plate support 255, and thus the second tape piece 25B may be substantially firmly attached to the second uncoated portion 17.

The first electrode plate stopping rollers 248, 249, 253, and 254 stop the movement of the electrode plate 11B passing through the first tape attachment point TA1 when the first tape piece 25A is attached to the electrode plate 11B. The first electrode plate stopping rollers may include the first upstream electrode plate stopping rollers 248 and 249 arranged on an upstream side of the first electrode plate support 245 along a movement path of the electrode plate 11B and the first downstream electrode plate stopping rollers 253 and 254 arranged on a downstream side of the first electrode plate support 245 along the movement path of the electrode plate 11B.

The first upstream electrode plate stopping rollers 248 and 249 may be provided as, or include, a pair of first upstream electrode plate stopping rollers 248 and 249, and the first downstream electrode plate stopping rollers 253 and 254 may be provided as, or include, a pair of first downstream electrode plate stopping rollers 253 and 254. The pair of first upstream electrode plate stopping rollers 248 and 249 may be substantially close to each other, and the pair of first downstream electrode plate stopping rollers 253 and 254 may be substantially close to each other.

When the electrode plate 11B passes between the pair of first upstream electrode plate stopping rollers 248 and 249 substantially close to each other and the pair of first downstream electrode plate stopping rollers 253 and 254 being substantially close to each other, and when the pair of first upstream electrode plate stopping rollers 248 and 249 and the pair of first downstream electrode plate stopping rollers 253 and 254 are stopped, a portion of the electrode plate 11B between the first upstream electrode plate stopping rollers 248 and 249 and the first downstream electrode plate stopping rollers 253 and 254 stops as well. In this case, the first rotating head 210A may attach the first tape piece 25A to the first uncoated portion 16 of the electrode plate 11B.

The second electrode plate stopping rollers 258, 259, 263, and 264 stop the movement of the electrode plate 11B passing through the second tape attachment point TA2 when the second tape piece 25B is attached to the electrode plate 11B. The second electrode plate stopping rollers may include the second upstream electrode plate stopping rollers 258 and 259 arranged on an upstream side of the second electrode plate support 255 along the movement path of the electrode plate 11B and the second downstream electrode plate stopping rollers 263 and 264 arranged on a downstream side of the second electrode plate support 255 along the movement path of the electrode plate 11B.

The second upstream electrode plate stopping rollers 258 and 259 may be provided as, or include, a pair of second upstream electrode plate stopping rollers 258 and 259, and the second downstream electrode plate stopping rollers 263 and 264 may be provided as, or include, a pair of second downstream electrode plate stopping rollers 263 and 264. The pair of second upstream electrode plate stopping rollers 258 and 259 may be substantially close to each other, and the pair of second downstream electrode plate stopping rollers 263 and 264 may be substantially close to each other.

When the electrode plate 11B passes between the pair of second upstream electrode plate stopping rollers 258 and 259 which are substantially close to each other and the pair of second downstream electrode plate stopping rollers 263 and 264 which are substantially close to each other, and when the pair of second upstream electrode plate stopping rollers 258 and 259 and the pair of second downstream electrode plate stopping rollers 263 and 264 are stopped, a portion of the electrode plate 11B between the second upstream electrode plate stopping rollers 258 and 259 and the second downstream electrode plate stopping rollers 263 and 264 stops as well. In this case, the second rotating head 210B may attach the second tape piece 25B to the second uncoated portion 17 of the electrode plate 11B.

The electrode plate tension rollers 266, 272 and 276 pull the electrode plate 11B so that tension of the electrode plate 11B is maintained. The electrode plate tension rollers may include the first electrode plate tension roller 266 located on an upstream side of the first electrode plate support 245 and the first upstream electrode plate stopping rollers 248 and 249 along the movement path of the electrode plate 11B, the second electrode plate tension roller 272 located between the first downstream electrode plate stopping rollers 253 and 254 and the second upstream electrode plate stopping rollers 258 and 259 along the movement path of the electrode plate 11B, and the third electrode plate tension roller 276 located on a downstream side of the second electrode plate support 255 and the second downstream electrode plate stopping rollers 263 and 264 along the movement path of the electrode plate 11B.

The electrode plate supply unit 240 may further include an upstream first electrode plate tension guide roller 268 on an upstream side of the first electrode plate tension roller 266 and a downstream first electrode plate tension guide roller 269 on a downstream side of the first electrode plate tension roller 266 along the movement path of the electrode plate 11B.

The electrode plate 11B supplied from the electrode plate supply roller 241 may sequentially pass through the upstream first electrode plate tension guide roller 268, the first electrode plate tension roller 266, the downstream first electrode plate tension guide roller 269, and a gap between the pair of first upstream electrode plate stopping rollers 248 and 249, and then move onto the first electrode plate support 245.

In this section, when a tensile force of the electrode plate 11B decreases, the first electrode plate tension roller 266 may move in a direction that increases the path of the electrode plate 11B, to increase the tensile force of the electrode plate 11B, and when the tensile force of the electrode plate 11B increases, the first electrode plate tension roller 266 may move in a direction that decreases the path of the electrode plate 11B, to decrease the tensile force of the electrode plate 11B. Accordingly, the tensile force of the electrode plate 11B supplied from the electrode plate supply roller 241 and moving to the first electrode plate support 245 may be maintained to be substantially uniform.

Since the first electrode plate tension roller 266 moves and the constant tensile force of the electrode plate 11B can be maintained, the electrode plate supply roller 241 may substantially continuously rotate without stopping to attach the first tape piece 25A to the electrode plate 11B while the pair of first upstream electrode plate stopping rollers 248 and 249 and the pair of first downstream electrode plate stopping rollers 253 and 254 are stopped.

The electrode plate supply unit 240 may further include an upstream second electrode plate tension guide roller 273 on an upstream side of the second electrode plate tension roller 272 and a downstream second electrode plate tension guide roller 274 on a downstream side of the second electrode plate tension roller 272 along the movement path of the electrode plate 11B.

In a section between the pair of first downstream electrode plate stopping rollers 253 and 254 and the pair of second upstream electrode plate stopping rollers 258 and 259, when the tensile force of the electrode plate 11B decreases, the second electrode plate tension roller 272 may move in a direction that increases the path of the electrode plate 11B, to increase the tensile force of the electrode plate 11B, and when the tensile force of the electrode plate 11B increases, the second electrode plate tension roller 272 may move in a direction that decreases the path of the electrode plate 11B, to decrease the tensile force of the electrode plate 11B. Accordingly, the tensile force of the electrode plate 11B from the first electrode plate support 245 to the second electrode plate support 255 can be maintained to be substantially uniform.

The electrode plate supply unit 240 may further include an upstream third electrode plate tension guide roller 278 on an upstream side of the third electrode plate tension roller 276 and a downstream third electrode plate tension guide roller 279 on a downstream side of the third electrode plate tension roller 276 along the movement path of the electrode plate 11B.

The electrode plate 11B, on which the second tape piece 25B is attached to the second uncoated portion 17, may pass between the pair of second downstream electrode plate stopping rollers 263 and 264, may pass, e.g., sequentially pass, through the upstream third electrode plate tension guide roller 278, the third electrode plate tension roller 276, and the downstream third electrode plate tension guide roller 279, and may be collected by the electrode plate collection roller 243.

In this section, when the tensile force of the electrode plate 11B decreases, the third electrode plate tension roller 276 may move in a direction that increases the path of the electrode plate 11B to increase the tensile force of the electrode plate 11B, and when the tensile force of the electrode plate 11B increases, the third electrode plate tension roller 276 may move in a direction that decreases the path of the electrode plate 11B to decrease the tensile force of the electrode plate 11B. Accordingly, the tension force of the electrode plate 11B moving from the second electrode plate support 255 to the electrode plate collection roller 243 may be maintained to be substantially uniform.

Since the third electrode plate tension roller 276 moves and the constant tensile force of the electrode plate 11B can be maintained, the electrode plate collection roller 243 may substantially continuously rotate without stopping to attach the second tape piece 25B to the electrode plate 11B while the pair of second upstream electrode plate stopping rollers 258 and 259 and the pair of second downstream electrode plate stopping rollers 263 and 264 are stopped.

The first rotating head 210A, which adsorbs the first tape piece 25A, may move to the first tape attachment point TA1, and the second rotating head 210B, which adsorbs the second tape piece 25B, may move to the second tape attachment point TA2, e.g., simultaneously or contemporaneously. In a state in which the first rotating head 210A and the first uncoated portion 16 of the electrode plate 11B are aligned in the radial direction of the rotation center RX, the first rotating head 210A may move in the radial direction from the rotation center RX to attach the first tape piece 25A to the first uncoated portion 16 of the electrode plate 11B. The first tape piece 25A may be attached to the electrode plate 11B to cover the first uncoated portion 16.

Further, in a state in which the second rotating head 210B and the second uncoated portion 17 of the electrode plate 11B are aligned in the radial direction of the rotation center RX, the second rotating head 210B may move in the radial direction from the rotation center RX to attach the second tape piece 25B to the second uncoated portion 17 of the electrode plate 11B. The second tape piece 25B may be attached to the electrode plate 11B to cover the second uncoated portion 17.

In an example, the rotating heads 210A and 210B may stop adsorbing the tape pieces 25A and 25B and return toward the rotation center RX. After the first tape piece 25A is attached to the electrode plate 11B, the first rotating head 210A may further rotate in the same rotation direction as a case in which the first rotating head 210A rotates to the first tape attachment point TA1 to move toward the first tape transfer point TF1. After the second tape piece 25B is attached to the electrode plate 11B, the second rotating head 210B may further rotate in the same rotation direction as a case in which the second rotating head 210B rotates to the second tape attachment point TA2 to move toward the second tape transfer point TF2.

Although not illustrated in FIGS. 9 and 10, the electrode tab welding unit, which welds the electrode tab (not illustrated) to the uncoated portions 16 and 17 of the electrode plate 11B, may be located on the movement path of the electrode plate 11B from the electrode plate supply roller 241 toward the first electrode plate tension roller 266. In this case, at the tape attachment points TA1 and TA2, the tape pieces 25A and 25B may be attached to the uncoated portions 16 and 17 to cover the uncoated portion 16 and 17 along with the portion of the electrode tab welded to the uncoated portion 16 and 17.

In the tape attaching apparatus 200 according to the other example embodiment of the present disclosure, the numbers of the plurality of tape transfer points TF1 and TF2 and the tape attachment points TA1 and TA2 are the same, and the number of rotating heads 210A and 210B is twice the number of tape transfer points TF1 and TF2 and the number of tape attachment points TA1 and TA2.

The tape pieces 25A and 25B are transferred to one of the plurality of the rotating heads 210A and 210B from the tape supply units 220A and 220B at one of the plurality of tape transfer points TF1 and TF2 and are transferred and attached to the electrode plate 11B from the one rotating head at one of the plurality of tape attachment points TA1 and TA2. The one tape transfer point and the one tape attachment point are spaced apart from each other at about 180° intervals with respect to the plurality of rotation centers RX.

A size of the tape pieces 25A and 25B transferred to one of the plurality of rotating heads 210A and 210B at one of the plurality of tape transfer points TF1 and TF2 is different from a size of the tape pieces 25A and 25B transferred to the other of the plurality of rotating heads 210A and 210B at the other of the plurality of tape transfer points TF1 and TF2.

The plurality of tape supply units 220A and 220B are provided in a one-to-one correspondence with the tape transfer points TF1 and TF2, and the one electrode plate supply unit 240 is provided.

The plurality of tape attachment points TA1 and TA2 are provided, the one electrode plate supply roller 241 is provided, and the plurality of electrode plate supports 245 and 255 are provided in a one-to-one correspondence with the tape attachment points TA1 and TA2. The plurality of electrode plate supports 245 and 255 are spaced apart from each other on the movement path of the electrode plate 11B supplied from the electrode plate supply roller 241.

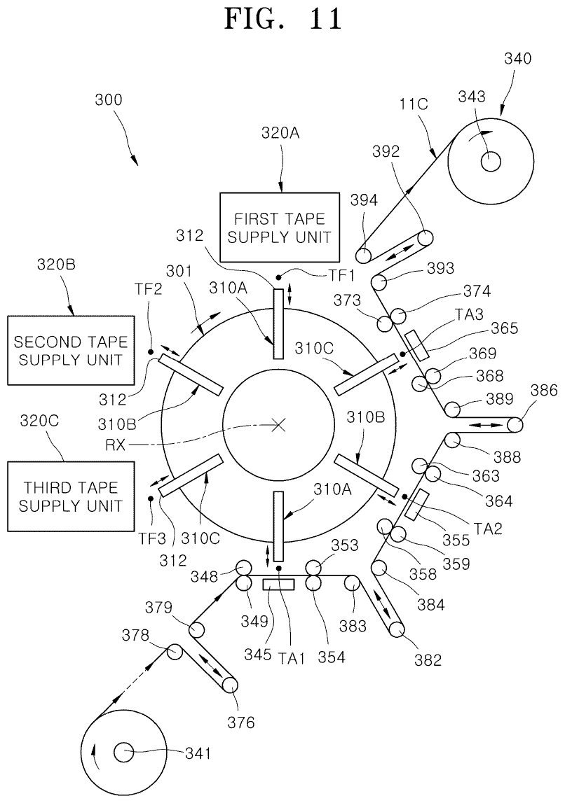

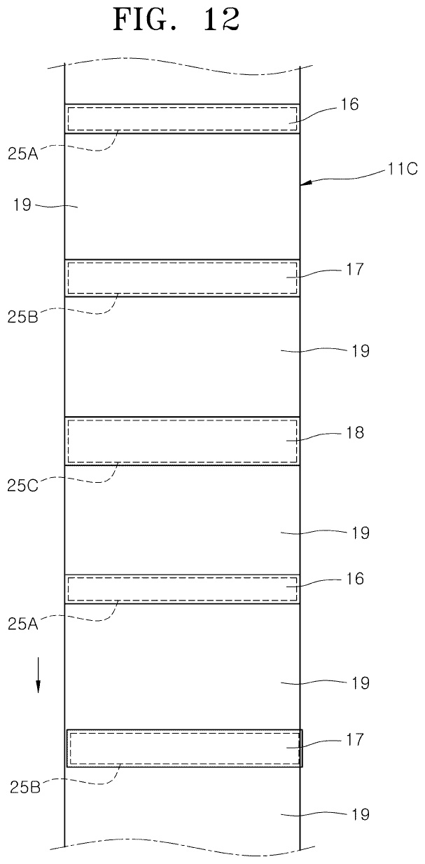

FIG. 11 is a diagram of a tape attaching apparatus according to a another embodiment of the present disclosure, and FIG. 12 is a plan view illustrating an example of the electrode plate to which the tape piece is attached by the tape attaching apparatus according to the example embodiment of the present disclosure. Referring to FIGS. 11 and 12, the tape attaching apparatus 300 according to the example embodiment of the present disclosure includes a plurality of tape supply units 320A, 320B, and 320C, and one electrode plate supply unit 340, a plurality of rotating heads 310A, 310B, and 310C, and a rotation frame 301.

The plurality of tape supply units 320A, 320B, and 320C supply the tape 20, specifically, tape pieces 25A, 25B, and 25C of the cut tape 20. The tape supply unit include the first tape supply unit 320A, the second tape supply unit 320B, and the third tape supply unit 320C.

The first tape supply unit 320A is configured to cut the substantially continuous tape 20 (see FIG. 2) and to supply the first tape piece 25A having the same size as the tape piece 25 illustrated in FIG. 8. The second tape supply unit 320B is configured to cut the tape 20 and to supply the second tape piece 25B that is larger than the first tape piece 25A. The third tape supply unit 320C is configured to cut the tape 20 and to supply the third tape piece 25C that is larger than the second tape piece 25B.

The width of the tape 20 cut into the second tape piece 25B may be greater than the width of the tape 20 cut into the first tape piece 25A, and a width of the tape 20 cut into the third tape piece 25C may be greater than the width of the tape 20 cut into the second tape piece 25B.

The rotating heads 310A, 310B, and 310C may be configured to receive the tape pieces 25A, 25B, and 25C supplied from the tape supply units 320A, 320B, and 320C and rotate to attach the tape piece 25A, 25B, and 25C to an electrode plate 11C supplied from the electrode plate supply unit 340.

The rotating heads 310A, 310B, and 310C may include the first rotating head 310A that is configured to receive and to adsorb the first tape piece 25A, a second rotating head 310B that is configured to receive and to adsorb the second tape piece 25B, and the third rotating head 310C that is configured to receive and to adsorb the third tape piece 25C. The first rotating head 310A may be provided as, or include, a pair of first rotating heads 310A, the second rotating head 310B may be provided as, or include, a pair of second rotating heads 310B, the third rotating head 310C may be provided as, or include, a pair of third rotating heads 310C, and a total of six rotating heads may be provided.

The pair of first rotating heads 310A, the pair of second rotating heads 310B, and the pair of third rotating heads 310C may be arranged at, e.g., equiangular intervals, in other words, about 60° intervals with respect to the same rotation center RX. The first rotating heads 310A, the second rotating heads 310B, and the third rotating heads 310C may be arranged sequentially. The pair of first rotating heads 310A may be arranged at about 180° intervals with respect to the rotation center RX, the pair of second rotating heads 310B may be arranged at about 180° intervals with respect to the rotation center RX, and the pair of third rotating heads 310C may be arranged at about 180° intervals with respect to the rotation center RX.

The rotation frame 301 may support the plurality of rotating heads 310A, 310B, and 310C and rotate about the rotation center RX. The rotation frame 301 may rotate in one direction. For example, the rotation frame 301 and the plurality of rotating heads 310A, 310B, and 310C may rotate about the rotation center RX in a counterclockwise direction.

Each, or at least one, of the rotating heads 310A, 310B, and 310C may move away from the rotation center RX and in back towards the center RX. In other words, the rotating heads 310A, 310B, and 310C may move in the radial direction and toward the rotation center RX.

A negative pressure may be formed at distal ends 312 of the rotating heads 310A, 310B, and 310C. Thus, the first tape piece 25A may be adsorbed to the distal end 312 of the first rotating head 310A, the second tape piece 25B may be adsorbed to the distal end 312 of the second rotating head 310B, and the third tape piece 25C may be adsorbed to the distal end 312 of the third rotating head 310C.

The first rotating head 310A may receive the first tape piece 25A from the first tape supply unit 320A at the first tape transfer point TF1 and rotate in one direction to attach the first tape piece 25A to the first uncoated portion 16 of the electrode plate 11C at the first tape attachment point TA1. The first tape transfer point TF1 and the first tape attachment point TA1 may be spaced apart from each other at about 180° intervals with respect to the rotation center RX.

The second rotating head 310B may receive the second tape piece 25B from the second tape supply unit 320B at the second tape transfer point TF2 and rotate in one direction to attach the second tape piece 25B to the second uncoated portion 17 of the electrode plate 11C at the second tape attachment point TA2. The second tape transfer point TF2 and the second tape attachment point TA2 may be spaced apart from each other at about 180° intervals with respect to the rotation center RX.

The third rotating head 310C may receive the third tape piece 25C from the first tape supply unit 220C at a third tape transfer point TF3 and rotate in one direction to attach the third tape piece 25C to a third uncoated portion 18 of the electrode plate 11C at a third tape attachment point TA3. The third tape transfer point TF3 and the third tape attachment point TA3 may be spaced apart from each other at about 180° intervals with respect to the rotation center RX.

The rotation frame 301 may rotate at a constant, or substantially constant, speed. However, at a moment that the plurality of rotating heads 310A, 310B, and 310C are positioned at the tape transfer points TF1, TF2, and TF3 or the tape attachment points TA1, TA2, and TA3, the rotation of the rotation frame 301 and the plurality of rotating heads 310A, 310B, and 310C supported thereon may temporarily stop.

For example, at a moment that the rotation of the rotation frame 301 is stopped, the first tape piece 25A is adsorbed to the distal end 312 of one of the pair of first rotating heads 310A at the first tape transfer point TF1, and the first tape piece 25A may be attached to the first uncoated portion 16 of the electrode plate 11C from the other first rotating head 310A at the first tape attachment point TA1.

The second tape piece 25B is adsorbed to the distal end 312 of one of the pair of second rotating heads 310B at the second tape transfer point TF2, and the second tape piece 25B may be attached to the second uncoated portion 17 of the electrode plate 11C from the other second rotating head 310B at the second tape attachment point TA2.

The third tape piece 25C is adsorbed to the distal end 312 of one of the pair of third rotating heads 310C at the third tape transfer point TF3, and the third tape piece 25C may be attached to the third uncoated portion 18 of the electrode plate 11C from the other third rotating head 310C at the third tape attachment point TA3.

In a state in which one of the pair of first rotating heads 310A rotates and moves to the first tape transfer point TF1, the first tape piece 25A is attached to the distal end 312 of the first rotating head 310A, and the first rotating head 310A rotates by about 180° in a counterclockwise direction and moves to the first tape attachment point TA1. Further, the first tape piece 25A attached to the first rotating head 310A at the first tape attachment point TA1 may be moved and attached to the first uncoated portion 16 of the electrode plate 11C, and the first rotating head 310A rotates by about 180° in a counterclockwise direction again and moves to the first tape transfer point TF1.

In a state in which one of the pair of second rotating heads 310B rotates and moves to the second tape transfer point TF2, the second tape piece 25B is attached to the distal end 312 of the second rotating head 310B, and the second rotating head 310B rotates by about 180° in a counterclockwise direction and moves to the second tape attachment point TA2. Further, the second tape piece 25B attached to the second rotating head 310B at the second tape attachment point TA2 is moved and attached to the second uncoated portion 17 of the electrode plate 11C, and the second rotating head 310B rotates by about 180° in a counterclockwise direction again and moves to the second tape transfer point TF2.

In a state in which one of the pair of third rotating heads 310C rotates and moves to the third tape transfer point TF3, the third tape piece 25C is attached to the distal end 312 of the third rotating head 310C, and the third rotating head 310C rotates by about 180° in a counterclockwise direction and moves to the third tape attachment point TA3. Further, the third tape piece 25C attached to the third rotating head 310C at the third tape attachment point TA3 is moved and attached to the third uncoated portion 18 of the electrode plate 11C, and the third rotating head 310C rotates by about 180° in a counterclockwise direction again and moves to the third tape transfer point TF3.

Since the first tape supply unit 320A has the same configuration as the tape supply unit 120 included in the tape attaching apparatus 100 according to the example embodiment of the present disclosure, a duplicated description thereof will be omitted. The second tape supply unit 320B and the third tape supply unit 320C have the same configuration as the tape supply unit 120 included in the tape attaching apparatus 100 according to the example embodiment of the present disclosure illustrated in FIG. 1 with a difference that the second tape piece 25B and the third tape piece 25C have different sizes from the size of the first tape piece 25A, and thus a duplicated description thereof is substantially omitted herein.

The electrode plate supply unit 340 may include an electrode plate supply roller 341, an electrode plate collection roller 343, electrode plate supports 345, 355, and 365, first electrode plate stopping rollers 348, 349, 353, and 354, second electrode plate stopping rollers 358, 359, 363, and 365, third electrode plate stopping rollers 368, 369, 373, and 374, a first electrode plate tension roller 376, a second electrode plate tension roller 382, a third electrode plate tension roller 386, and a fourth electrode plate tension roller 392. The electrode plate supply roller 341 unwinds the electrode plate 11C wound in the form of a roll and substantially seamlessly and continuously supplies the unwound electrode plate 11B.

The electrode plate 11C may be provided with, or include, the first uncoated portion 16, the second uncoated portion 17, the third uncoated portion 18 that is not coated with the electrode active material layer 14, and the mixture portion 19 coated with the electrode active material layer 14. The planar size of the second uncoated portion 17 may be greater than the planar size of the first uncoated portion 16, and a planar size of the third uncoated portion 18 may be greater than the planar size of the second uncoated portion 17. The planar size of the first uncoated portion 16 may correspond to the planar size of the first tape piece 25A, the planar size of the second uncoated portion 17 may correspond to the planar size of the second tape piece 25B, and the planar size of the third uncoated portion 18 may correspond to a planar size of the third tape piece 25C.

The first uncoated portion 16, the second uncoated portion 17, and the third uncoated portion 18 may be spaced apart from each other in a longitudinal direction of the electrode plate 11C, with the mixture portion 19 interposed therebetween. The first uncoated portion 16, the second uncoated portion 17, and the third uncoated portion 18 may be arranged sequentially.

The electrode plate collection roller 343 is configured to wind the electrode plate 11C into a roll shape and to collect the electrode plate 11C in which the first tape piece 25A is attached to the first uncoated portion 16, the second tape piece 25B is attached to the second uncoated portion 17, and the third tape piece 25C is attached to the third uncoated portion 18.

The electrode plate supports 345, 355, and 365 may be provided as, or include, three electrode plate supports 345, 355, and 365. The first electrode plate support 345 supports the electrode plate 11C at the first tape attachment point TA1. The second electrode plate support 355 supports the electrode plate 11C at the second tape attachment point TA2. The third electrode plate support 365 supports the electrode plate 11C at the third tape attachment point TA3.

The first rotating head 310A, which adsorbs the first tape piece 25A at the distal end 312 and rotates to move to the first tape attachment point TA1, pushes the first tape piece 25A toward the electrode plate 11C so that the adhesive surface of the first tape piece 25A adheres to the first uncoated portion 16 of the electrode plate 11C. The first rotating head 310A moves in the radial direction and away from the rotation center RX, the adhesive surface of the first tape piece 25A is pressed against and in close contact with the first uncoated portion 16 of the electrode plate 11C supported on the first electrode plate support 345, and thus the first tape piece 25A may be substantially firmly attached to the first uncoated portion 16.

The second rotating head 310B, which adsorbs the second tape piece 25B at the distal end 312 and rotates to move to the second tape attachment point TA2, pushes the second tape piece 25B toward the electrode plate 11C so that the adhesive surface of the second tape piece 25B adheres to the second uncoated portion 17 of the electrode plate 11C. The second rotating head 310B moves in the radial direction and away from the rotation center RX, the adhesive surface of the second tape piece 25B is pressed against and in close contact with the second uncoated portion 17 of the electrode plate 11C supported on the second electrode plate support 355, and thus the second tape piece 25B may be substantially firmly attached to the second uncoated portion 17.

The third rotating head 310C, which is configured to adsorb the third tape piece 25C at the distal end 312 and to rotate to move to the third tape attachment point TA3, pushes the third tape piece 25C toward the electrode plate 11C so that an adhesive surface of the third tape piece 25C adheres to the third uncoated portion 18 of the electrode plate 11C. The third rotating head 310C moves in the radial direction and away from the rotation center RX, the adhesive surface of the third tape piece 25C is pressed against and in close contact with the third uncoated portion 18 of the electrode plate 11C supported on the third electrode plate support 365, and thus the third tape piece 25C may be substantially firmly attached to the third uncoated portion 18.

The first electrode plate stopping rollers 348, 349, 353, and 354 are configured to stop the movement of the electrode plate 11C passing through the first tape attachment point TA1 when the first tape piece 25A is attached to the electrode plate 11C. The first electrode plate stopping rollers may include the first upstream electrode plate stopping rollers 348 and 349 arranged on an upstream side of the first electrode plate support 345 along a movement path of the electrode plate 11C, and the first downstream electrode plate stopping rollers 353 and 354 arranged on a downstream side of the first electrode plate support 345 along the movement path of the electrode plate 11C.

The first upstream electrode plate stopping rollers 348 and 349 may be provided as, or include, a pair of first upstream electrode plate stopping rollers 248 and 249, and the first downstream electrode plate stopping rollers 353 and 354 may be provided as, or include, a pair of first downstream electrode plate stopping rollers 253 and 254. The pair of first upstream electrode plate stopping rollers 348 and 349 may be substantially close to each other, and the pair of first downstream electrode plate stopping rollers 353 and 354 may be substantially close to each other.

When the electrode plate 11C passes between the pair of first upstream electrode plate stopping rollers 348 and 349 substantially close to each other and the pair of first downstream electrode plate stopping rollers 353 and 354 substantially close to each other, and when the pair of first upstream electrode plate stopping rollers 348 and 349 and the pair of first downstream electrode plate stopping rollers 353 and 354 are stopped, a portion of the electrode plate 11C between the first upstream electrode plate stopping rollers 348 and 349 and the first downstream electrode plate stopping rollers 353 and 354 stops as well. In this case, the first rotating head 310A may attach the first tape piece 25A to the first uncoated portion 16 of the electrode plate 11C.

The second electrode plate stopping rollers 358, 359, 363, and 364 stop the movement of the electrode plate 11C passing through the second tape attachment point TA2 when the second tape piece 25B is attached to the electrode plate 11C. The second electrode plate stopping rollers may include the second upstream electrode plate stopping rollers 358 and 359 arranged on an upstream side of the second electrode plate support 355 along the movement path of the electrode plate 11C and the second downstream electrode plate stopping rollers 363 and 364 arranged on a downstream side of the second electrode plate support 355 along the movement path of the electrode plate 11C.

The second upstream electrode plate stopping rollers 358 and 359 may be provided as, or include, a pair of second upstream electrode plate stopping rollers 358 and 359, and the second downstream electrode plate stopping rollers 363 and 364 may be provided as, or include, a pair of second downstream electrode plate stopping rollers 363 and 364. The pair of second upstream electrode plate stopping rollers 358 and 359 may be substantially close to each other, and the pair of second downstream electrode plate stopping rollers 363 and 364 may be substantially close to each other.

When the electrode plate 11C passes between the pair of second upstream electrode plate stopping rollers 358 and 359 substantially close to each other and the pair of second downstream electrode plate stopping rollers 363 and 364 substantially close to each other, and when the pair of second upstream electrode plate stopping rollers 358 and 359 and the pair of second downstream electrode plate stopping rollers 363 and 364 are stopped, a portion of the electrode plate 11C between the second upstream electrode plate stopping rollers 358 and 359 and the second downstream electrode plate stopping rollers 363 and 364 stops as well. In this case, the second rotating head 310B may attach the second tape piece 25A to the second uncoated portion 17 of the electrode plate 11C.

The third electrode plate stopping rollers 368, 369, 373, and 374 stop the movement of the electrode plate 11C passing through the third tape attachment point TA3 when the third tape piece 25C is attached to the electrode plate 11C. The third electrode plate stopping rollers may include the third upstream electrode plate stopping rollers 368 and 369 arranged on an upstream side of the third electrode plate support 365 along the movement path of the electrode plate 11C and the third downstream electrode plate stopping rollers 373 and 374 arranged on a downstream side of the third electrode plate support 365 along the movement path of the electrode plate 11C.

The third upstream electrode plate stopping rollers 368 and 369 may be provided as, or include, a pair of third upstream electrode plate stopping rollers 368 and 369, and the third downstream electrode plate stopping rollers 373 and 374 may be provided as, or include, a pair of third downstream electrode plate stopping rollers 373 and 374. The pair of third upstream electrode plate stopping rollers 368 and 369 may be substantially close to each other, and the pair of third downstream electrode plate stopping rollers 373 and 374 may be substantially close to each other.

When the electrode plate 11C passes between the pair of third upstream electrode plate stopping rollers 368 and 369 that are substantially close to each other and the pair of third downstream electrode plate stopping rollers 373 and 374 that are substantially close to each other, and when the pair of third upstream electrode plate stopping rollers 368 and 369 and the pair of third downstream electrode plate stopping rollers 373 and 374 are stopped, a portion of the electrode plate 11C between the third upstream electrode plate stopping rollers 368 and 369 and the third downstream electrode plate stopping rollers 373 and 374 stops as well. In this case, the third rotating head 310C may attach the third tape piece 25C to the third uncoated portion 18 of the electrode plate 11C.

The electrode plate tension rollers 376, 382, 386 and 392 pull the electrode plate 11C so that tension of the electrode plate 11C is maintained. The electrode plate tension rollers may include a first electrode plate tension roller 376 located on an upstream side of the first electrode plate support 345 and the first upstream electrode plate stopping rollers 348 and 349 along the movement path of the electrode plate 11C, a second electrode plate tension roller 382 located between the first downstream electrode plate stopping rollers 353 and 354 and the second upstream electrode plate stopping rollers 358 and 359 along the movement path of the electrode plate 11C, a third electrode plate tension roller 386 located between the second downstream electrode plate stopping rollers 363 and 364 and the third upstream electrode plate stopping rollers 368 and 369 along the movement path of the electrode plate 11C, and a fourth electrode plate tension roller 392 located on a downstream side of the third electrode plate support 365 and the third downstream electrode plate stopping rollers 373 and 374 along the movement path of the electrode plate 11C.

The electrode plate supply unit 340 may further include an upstream first electrode plate tension guide roller 378 on an upstream side of the first electrode plate tension roller 376 and a downstream first electrode plate tension guide roller 379 on a downstream side of the first electrode plate tension roller 376 along the movement path of the electrode plate 11C.

The electrode plate 11C supplied from the electrode plate supply roller 341 may sequentially pass through the upstream first electrode plate tension guide roller 378, the first electrode plate tension roller 376, the downstream first electrode plate tension guide roller 379, and a gap between the pair of first upstream electrode plate stopping rollers 348 and 349, and then move onto the first electrode plate support 345.

In this section, when a tensile force of the electrode plate 11C decreases, the first electrode plate tension roller 376 may move in a direction that increases the path of the electrode plate 11C, to increase the tensile force of the electrode plate 11C, and when the tensile force of the electrode plate 11C increases, the first electrode plate tension roller 376 may move in a direction that decreases the path of the electrode plate 11C, to decrease the tensile force of the electrode plate 11C. Accordingly, the tensile force of the electrode plate 11C supplied from the electrode plate supply roller 341 and moving to the first electrode plate support 345 may be maintained to be substantially uniform.

Since the first electrode plate tension roller 376 moves and the constant tensile force of the electrode plate 11C can be maintained, the electrode plate supply roller 341 may substantially continuously rotate without stopping to attach the first tape piece 25A to the electrode plate 11C while the pair of first upstream electrode plate stopping rollers 348 and 349 and the pair of first downstream electrode plate stopping rollers 353 and 354 are stopped.

The electrode plate supply unit 340 may further include an upstream second electrode plate tension guide roller 383 on an upstream side of the second electrode plate tension roller 382 and a downstream second electrode plate tension guide roller 384 on a downstream side of the second electrode plate tension roller 382 along the movement path of the electrode plate 11C.

In a section between the pair of first downstream electrode plate stopping rollers 353 and 354 and the pair of second upstream electrode plate stopping rollers 358 and 359, when the tensile force of the electrode plate 11C decreases, the second electrode plate tension roller 382 may move in a direction that increases the path of the electrode plate 11C, to increase the tensile force of the electrode plate 11C, and when the tensile force of the electrode plate 11C increases, the second electrode plate tension roller 382 may move in a direction that decreases the path of the electrode plate 11C, to decrease the tensile force of the electrode plate 11C. Accordingly, the tensile force of the electrode plate 11C moving from the electrode plate supply roller 345 toward the first electrode plate support 355 may be maintained to be substantially uniform.

The electrode plate supply unit 340 may further include an upstream third electrode plate tension guide roller 388 on an upstream side of the third electrode plate tension roller 386 and a downstream third electrode plate tension guide roller 389 on a downstream side of the third electrode plate tension roller 386 along the movement path of the electrode plate 11C.

In a section between the pair of second downstream electrode plate stopping rollers 363 and 364 and the pair of third upstream electrode plate stopping rollers 368 and 369, when the tensile force of the electrode plate 11C decreases, the third electrode plate tension roller 386 may move in a direction that increases the path of the electrode plate 11C, to increase the tensile force of the electrode plate 11C, and when the tensile force of the electrode plate 11C increases, the third electrode plate tension roller 386 may move in a direction that decreases the path of the electrode plate, to decrease the tensile force of the electrode plate 11C. Accordingly, the tension force of the electrode plate 11C moving from the second electrode plate support 355 toward the third electrode plate support 365 may be maintained to be substantially uniform.

The electrode plate supply unit 340 may further include an upstream fourth electrode plate tension guide roller 393 on an upstream side of the fourth electrode plate tension roller 392, and a downstream fourth electrode plate tension guide roller 394 on a downstream side of the fourth electrode plate tension roller 392 along the movement path of the electrode plate 11C.

The electrode plate 11C, on which the third tape piece 25C is attached to the third uncoated portion 18, may pass between the pair of third downstream electrode plate stopping rollers 373 and 374, may sequentially pass through the upstream fourth electrode plate tension guide roller 393, the fourth electrode plate tension roller 392, and the downstream fourth electrode plate tension guide roller 394, and may be collected by the electrode plate collection roller 343.

In this section, when the tensile force of the electrode plate 11C decreases, the fourth electrode plate tension roller 392 may move in a direction that increases the path of the electrode plate 11C, to increase the tensile force of the electrode plate 11C, and when the tensile force of the electrode plate 11C increases, the fourth electrode plate tension roller 392 may move in a direction that decreases the path of the electrode plate 11C, to decrease the tensile force of the electrode plate 11C. Accordingly, the tension force of the electrode plate 11C moving from the third electrode plate support 365 toward the electrode plate collection roller 343 may be maintained to be substantially uniform.

Because the fourth electrode plate tension roller 392 moves and the constant tensile force of the electrode plate 11C can be maintained, the electrode plate collection roller 343 may substantially continuously rotate without stopping to attach the third tape piece 25C to the electrode plate 11C while the pair of third upstream electrode plate stopping rollers 368 and 369 and the pair of third downstream electrode plate stopping rollers 373 and 374 are stopped.

The first rotating head 310A, which adsorbs the first tape piece 25A, may move to the first tape attachment point TA1, contemporaneously or at the same time, the second rotating head 310B, which adsorbs the second tape piece 25B, may move to the second tape attachment point TA2, and the third rotating head 310C, which adsorbs the third tape piece 25C, may move to the third tape attachment point TA3.

In a state in which the first rotating head 310A and the first uncoated portion 16 of the electrode plate 11C are aligned in the radial direction of the rotation center RX, the first rotating head 310A may move in the radial direction from the rotation center RX to attach the first tape piece 25A to the first uncoated portion 16 of the electrode plate 11C. The first tape piece 25A may be attached to the electrode plate 11C to cover the first uncoated portion 16.

In a state in which the second rotating head 310B and the second uncoated portion 17 of the electrode plate 11C are aligned in the radial direction of the rotation center RX, the second rotating head 310B may move in the radial direction from the rotation center RX to attach the second tape piece 25B to the second uncoated portion 17 of the electrode plate 11C. The second tape piece 25B may be attached to the electrode plate 11C to cover the second uncoated portion 17.

In a state in which the third rotating head 310C and the third uncoated portion 18 of the electrode plate 11C are aligned in the radial direction of the rotation center RX, the third rotating head 310C may move in the radial direction from the rotation center RX to attach the third tape piece 25C to the third uncoated portion 18 of the electrode plate 11C. The third tape piece 25C may be attached to the electrode plate 11C to cover the third uncoated portion 18.

In various examples, the rotating heads 310A, 310B, and 310C may stop adsorbing the tape pieces 25A, 25B, and 25C and return toward the rotation center RX. After the first tape piece 25A is attached to the electrode plate 11C, the first rotating head 310A may further rotate in the same rotation direction as a case in which the first rotating head 210A rotates to the first tape attachment point TA1 to move toward the first tape transfer point TF1.

After the second tape piece 25B is attached to the electrode plate 11C, the second rotating head 310B may further rotate in the same rotation direction as a case in which the second rotating head 310B rotates to the second tape attachment point TA2 to move toward the second tape transfer point TF2. After the third tape piece 25C is attached to the electrode plate 11C, the third rotating head 310C may further rotate in the same rotation direction as a case in which the third rotating head 310C rotates to the third tape attachment point TA3 to move toward the third tape transfer point TF3.

Although not illustrated in FIGS. 11 and 12, the electrode tab welding unit, which welds the electrode tab (not illustrated) to the uncoated portions 16, 17 and 18 of the electrode plate 11C, may be located on the movement path of the electrode plate 11C from the electrode plate supply roller 341 toward the first electrode plate tension roller 376. In this case, at the tape attachment points TA1, TA2 and TA3, the tape pieces 25A, 25B, and 25C may be attached to the uncoated portions 16, 17, and 18 to cover the uncoated portion 16, 17, and 18 along with the portion of the electrode tab welded to the uncoated portion 16, 17 and, 18.

In the tape attaching apparatus 300 according to the example embodiment of the present disclosure, the numbers of the plurality of tape transfer points TF1, TF2, and TF3 and the tape attachment points TA1, TA2, and TA3 are the same, and the number of rotating heads 310A, 310B, and 310C is twice the number of tape transfer points TF1, TF2, and TF3 and the number of tape attachment points TA1, TA2, and TA3.

The tape pieces 25A, 25B, 24C are transferred to one of the plurality of the rotating heads 310A, 310B, and 310C from the tape supply units 320A, 320B, and 320C at one of the plurality of tape transfer points TF1, TF2, and TF3 and are transferred and attached to the electrode plate 11C from the one rotating head at one of the plurality of tape attachment points TA1, TA2, and TA3. The one tape transfer point and the one tape attachment point are spaced apart from each other at about 180° intervals with respect to the plurality of rotation centers RX.

A size of the tape pieces 25A, 25B, and 25C transferred to one of the plurality of rotating heads 310A, 310B, and 310C at one of the plurality of tape transfer points TF1, TF1 and TF2 is different from a size of the tape pieces 25A, 25B, and 25C transferred to another of the plurality of rotating heads 310A, 310B, and 310C at another of the plurality of tape transfer points TF1, TF2 and, TF3.

The plurality of tape supply units 320A, 320B, and 320C are provided in a one-to-one correspondence with the tape transfer points TF1, TF2, and TF3, and the one electrode plate supply unit 340 is provided.

The plurality of tape attachment points TA1, TA2, and TA3 are provided, the one electrode plate supply roller 341 is provided, and the plurality of electrode plate supports 345, 355, and 365 are provided in a one-to-one correspondence with the tape attachment points TA1, TA2, and TA3. The plurality of electrode plate supports 345, 355 and 365 are spaced apart from each other on the movement path of the electrode plate 11C supplied from the electrode plate supply roller 341.

According to an example embodiment of the present disclosure, a head that receives a tape and attaches the tape to an electrode plate does not move in a straight line but rotates. Accordingly, a tape supply unit and an electrode plate supply unit can be arranged around the rotating head, and thus a small size of a tape attaching apparatus is easily designed. Therefore, an installation space of a tape attaching apparatus can be reduced or minimized, manufacturing costs of a secondary battery can be reduced, and accuracy of a tape attachment position can be improved.

According to example embodiments of the present disclosure, a plurality of rotating heads are arranged to rotate about the same rotation center in one direction, and thus productivity of tape attaching work can be easily improved.

However, aspects and features of the present invention are not limited to those described above and other aspects and features not mentioned will be clearly understood by those skilled in the art from the detailed description given above.

Although the present invention has been described with reference to some example embodiments and drawings illustrating aspects thereof, the present invention is not limited thereto. Various modifications and variations can be made by a person skilled in the art to which the present invention belongs within the scope of the technical spirit of the invention and the claims and equivalents thereto.

What is claimed is:

1. A tape attaching apparatus comprising:
a tape supply unit configured to supply a tape;
an electrode plate supply unit configured to supply an electrode plate; and
a rotating head configured to receive the tape supplied from the tape supply unit and to rotate so as to attach the tape to the electrode plate supplied from the electrode plate supply unit.

2. The tape attaching apparatus as claimed in claim 1, wherein the rotating head is configured to receive the tape from the tape supply unit at a tape transfer point, and is configured to rotate in one direction to attach the tape to the electrode plate at a tape attachment point.

3. The tape attaching apparatus as claimed in claim 2, wherein, the rotating head is further configured to rotate in the one direction to return to the tape transfer point when the tape is attached to the electrode plate at the tape attachment point.

4. The tape attaching apparatus as claimed in claim 2, wherein the tape includes an adhesive surface coated with an adhesive, and a non-adhesive surface which is opposite to the adhesive surface and is not coated with the adhesive, and
the rotating head is configured to adsorb the non-adhesive surface at the tape transfer point and to stop the adsorption of the non-adhesive surface at the tape attachment point.

5. The tape attaching apparatus as claimed in claim 4, wherein the rotating head is configured to push the tape toward the electrode plate to facilitate adhesion of the adhesive surface to the electrode plate at the tape attachment point.

6. The tape attaching apparatus as claimed in claim 2, wherein the rotating head comprises a plurality of rotating heads, and
the plurality of rotating heads are arranged at equiangular intervals with respect to the same rotation center.

7. The tape attaching apparatus as claimed in claim 6, further comprising a rotation frame configured to support the plurality of rotating heads, the rotation from being configured to rotate about the rotation center.

8. The tape attaching apparatus as claimed in claim 2, wherein the tape transfer point is comprises as a plurality of tape transfer points, the tape attachment point comprises a plurality of tape attachment points, and the number of tape transfer points is equal to the number of tape attachment points, and
a number of rotating heads is twice the number of tape transfer points and the number of tape attachment points.

9. The tape attaching apparatus as claimed in claim 8, wherein the tape is transferred to one of the plurality of rotating heads from the tape supply unit at one of the plurality of tape transfer points, transferred to the electrode plate from the one rotating head at one of the plurality of tape attachment points, and attached to the electrode plate, and
the tape transfer point and the tape attachment point are spaced apart from each other by about 180° with respect to a rotation center of the rotating head.

10. The tape attaching apparatus as claimed in claim 8, wherein a size of the tape transferred to one of the plurality of rotating heads at one of the plurality of tape transfer points is different from a size of the tape transferred to another of the plurality of rotating heads at another of the plurality of tape transfer points.

11. The tape attaching apparatus as claimed in claim 8, wherein the tape supply unit comprises a plurality of tape supply units in a one-to-one correspondence with the tape transfer points, and
the electrode plate supply unit comprises one electrode plate supply unit.

12. The tape attaching apparatus as claimed in claim 1, wherein the tape supply unit comprises:
a tape supply roller configured to substantially continuously supply the tape; and
a tape cutter configured to cut the tape supplied from the tape supply roller to a preset length.

13. The tape attaching apparatus as claimed in claim 12, wherein the tape supply unit further comprises a tape gripper configured to grip an end portion of the tape fed from the tape supply roller.

14. The tape attaching apparatus as claimed in claim 12, wherein, the rotating head is configured to adsorb the tape when the tape gripper grips the tape, and
the tape cutter is configured to cut the tape when the tape is adsorbed to the rotating head.

15. The tape attaching apparatus as claimed in claim 14, wherein the tape supply unit further comprises a tape tension roller configured to pull the tape so that tension of the tape is substantially maintained.

16. The tape attaching apparatus as claimed in claim 2, wherein the electrode plate supply unit comprises:
an electrode plate supply roller configured to substantially continuously supply the electrode plate; and
an electrode plate support configured to support the electrode plate at the tape attachment point.

17. The tape attaching apparatus as claimed in claim 16, wherein the electrode plate supply unit further comprises an electrode plate stopping roller configured to stop movement of the electrode plate passing through the tape attachment point when the tape is attached to the electrode plate.

18. The tape attaching apparatus as claimed in claim 17, wherein the rotating head is configured to rotate after adsorbing the tape at the tape transfer point, to move in a radial direction from a rotation center of the rotating head at the tape attachment point to attach the tape to the electrode plate, to stop the adsorbing of the tape, and to return toward the rotation center.

19. The tape attaching apparatus as claimed in claim 17, wherein the electrode plate supply unit further comprises an electrode plate tension roller configured to pull the electrode plate so that tension of the electrode plate is substantially maintained.

20. The tape attaching apparatus as claimed in claim 16, wherein the tape attachment point comprises a plurality of tape attachment points,
the electrode plate supply roller comprises one electrode plate supply roller,
the electrode plate support comprises a plurality of electrode plate supports in a one-to-one correspondence with the tape attachment points, and
the plurality of electrode plate supports are spaced apart from each other on a movement path of the electrode plate supplied from the electrode plate supply roller.
